(19) United States
(12) Patent Application Publication
(10) Pub. No.: US 2011/0154656 A1
(43) Pub. Date: Jun. 30, 2011

(54) SYSTEMS AND METHODS FOR MANUFACTURING MODIFIED IMPEDANCE COAXIAL CABLES

(76) Inventors: Joe A. Harrison, Olympia, WA (US); Songnan Yang, San Jose, CA (US); Michael A. Link, Hillsboro, OR (US)

(21) Appl. No.: 12/975,433

(22) Filed: Dec. 22, 2010

Related U.S. Application Data
(63) Continuation-in-part of application No. 12/590,353, filed on Nov. 6, 2009.

(51) Int. Cl. H01B 13/20

(52) U.S. Cl. 29/828

(57) ABSTRACT

Systems and methods for manufacturing modified impedance coaxial cables including providing a coaxial cable having an inner conductor, a dielectric layer at least partially covering an outer surface of the inner conductor, and an outer conductor at least partially covering an outer surface of the dielectric layer. The coaxial cable may include a first section having a first impedance configured to allow a first frequency band to pass. A discontinuity section may be formed in at least one of the inner conductor, the dielectric layer, and the outer conductor. The discontinuity section may have an impedance different than the first impedance and a length which is configured to attenuate a second frequency band.

### CROSS REFERENCE TO RELATED APPLICATIONS

This application is a continuation-in-part of U.S. patent application Ser. No. 12/590,353, filed on Nov. 11, 2009 and entitled RADIO FREQUENCY FILTERING IN COAXIAL CABLES WITHIN A COMPUTER SYSTEM, which is fully incorporated herein by reference.

### TECHNICAL FIELD

The present disclosure generally relates to coaxial cables, and, more particularly, to systems and method for manufacturing coaxial cables having a modified impedance.

### BACKGROUND

Generally, two radios co-located on the same computer platform (for example, but not limited to, located within a laptop, notebook netbook, and/or a tablet computer system) may need high isolation to function optimally. In particular, the isolation between the two radios in the computer platform may be necessary to prevent each radio from interfering with the reception of the other radio. The isolation may be achieved through highly selective filters on the front-end of a radio transceiver and/or a high isolation between the two radios' antennas.

As more and more radios and antennas are integrated in a computer system, achieving a high isolation between closely spaced antennas may be increasingly difficult and, as a result, a more stringent filter requirement may be forced upon the wireless module. The performance of the front-end filter on the wireless module may be compromised due to cost and real estate constraints. Consequently, many radio co-existence issues in computer systems (such as, but not limited to, mobile computing systems such as laptops, notebooks, netbooks, tablets and the like) are caused by front-end saturation and/or strong out-of-bound (OOB) interference from other embedded radios operating at a nearby frequency band.

Additionally, excessive filtering may be required to reject spurious emission of transmission in order to obtain regulatory compliance in a computer system comprising a single radio. This filtering may be inadequate in a radio module prototype or hard to achieve on a low cost radio solution. As a result, solving these problems at a modular level may incur significant cost increases and time to market delays.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates one example system embodiment consistent with the present disclosure;

FIG. 2 illustrates one embodiment of a wireless radio systems consistent with the present disclosure;

FIG. 3 is a cross-sectional view illustrating one embodiment a modified controlled impedance coaxial cable consistent with the present disclosure;

FIG. 4 illustrates one embodiment of a modified controlled impedance coaxial cable consistent with the present disclosure;

FIG. 5 illustrates another embodiment of a modified controlled impedance coaxial cable consistent with the present disclosure;

FIGS. 6-12 illustrate various embodiments of systems and methods for manufacturing a modified controlled impedance coaxial cable consistent with the present disclosure; and

FIG. 13 illustrates an example showing a simulated insertion loss of a modified controlled impedance coaxial cable consistent with the present disclosure.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

In general, the present disclosure includes systems and methods employing modified controlled impedance coaxial cables as well as systems and methods for manufacturing the same. The modified controlled impedance coaxial cables of the present disclosure may include one or more sections having an impedance which is different from the remainder of the coaxial cable such that one or more radio frequencies (RF) are filtered (e.g., blocked) and the modified controlled impedance coaxial cables operates as an in-line-filter. The modified controlled impedance coaxial cables may be configured to connect an antenna to a wireless module in a variety of computer platforms (including, but not limited to, a desktop personal computer (PC), a laptop, a notebook, an ultra mobile pc (UMPC), a handheld computing device, a game console, a multimedia appliance, a digital recording device for audio/video, a smart phone, a netbook computer system, tablet computers and the like).

Providing a coaxial cable having an in-line filter may reduce and/or eliminate the requirements of the filter on a wireless module, thereby leading not only to cost savings, but also improving radio coexistence performances of the computing platform while also reducing the real estate requirements needed to provide the desired isolation. Additionally, a coaxial cable having an in-line filter may also suppress the out-of-band (OOB) spurious emissions of a radio to help the radio to pass any regulatory tests.

The present disclosure also includes systems and methods for manufacturing modified controlled impedance coaxial cables. For example, the present disclosure includes systems and methods for manufacturing modified controlled impedance coaxial cables which require minimal changes to existing manufacturing techniques. As a result, the modified controlled impedance coaxial cable may be manufactured at a cost the same as, or similar to, standard coaxial cables having a constant impedance.

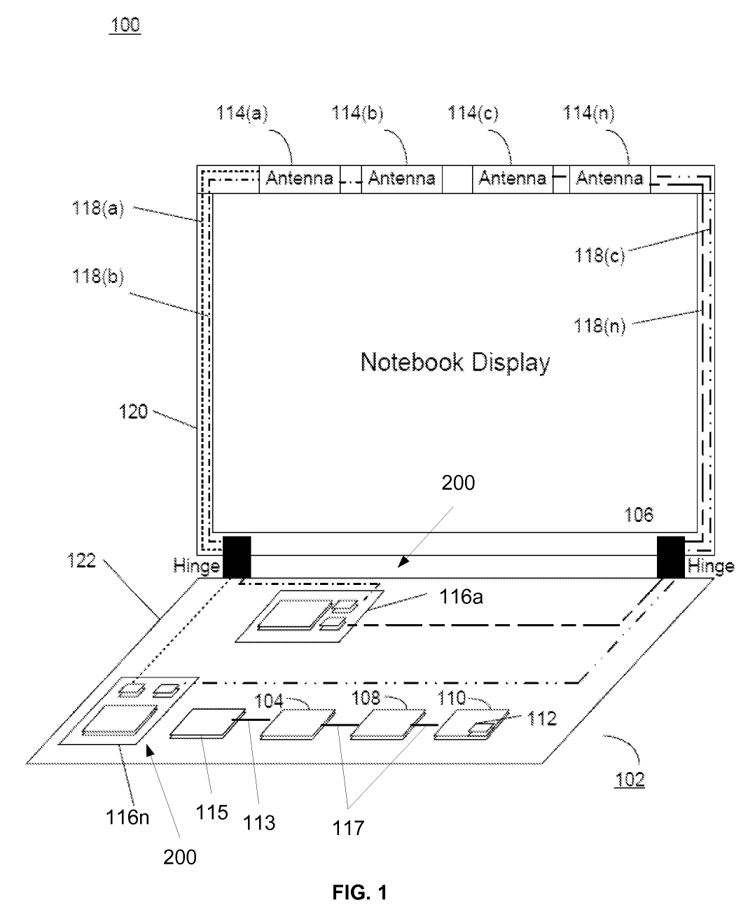

Turning now to FIG. 1, one embodiment of a computer system 100 including a computing device 102 and one or more modified controlled impedance coaxial cables 118a-n consistent with the present disclosure are generally illustrated. While the computing device 102 is illustrated as a notebook, one of ordinary skill in the art will understand that the computing device 102 may include any computing device such as, but not limited to, a desktop PC, a laptop, an UMPC, a handheld computing device, a game console, a multimedia appliance, a digital recording device for audio/video, a smart phone, a netbook computer system, tablet computers, and the like.

The computing device 102 may include a processor core 104, a display device 106 (for example, but not limited to, a conventional monitor, a liquid crystal display (LCD), a projector, and the like), a network interface device 115, memory 108 and/or 110, one or more wireless radio systems 200. The processor core 104 may include a processing unit of any type of architecture which has the primary logic, operation devices, controllers, memory systems, and so forth of the computing device 102. For instance, the processor core 104 may incorporate one or more processing devices and a chipset having functionality for memory control, input/output control, graphics processing, and so forth. The processor core 104 may be communicatively coupled via an interconnect 113 to a network interface device and/or a plurality of input/output (I/O) devices (collectively 115). The interconnect 113 may represent the primary high speed interconnects between components/devices of the host computing device 102, such as those employed in traditional computing chipsets. The interconnect 113 may be point-to-point or connected to multiple devices (e.g., bussed). The I/O devices 115 may include a variety of I/O devices configured to perform I/O functions such as, but not limited to, controllers/devices for input functions (e.g., keyboard, mouse, trackball, pointing device), media cards (e.g., audio, video, graphic), network cards and other peripheral controllers, LAN cards, speakers, camera, and the like.

The network interface device 115 may be configured to establish a connection (for example, wireless and/or wired connection) between the computing device 102 and one or more networks (such as, but not limited to, the Internet, an intranet, a peer-to-to peer network, and the like). The network interface 115 may be configured to perform a variety of signal processing functions associated with network communications.

The processor core 104 may also be coupled via a memory bus 117 to memory 108 and/or 110. According to one embodiment, memory 108 may include a “main” memory configured to store and/or execute system code and data. The “main” memory 108 may be implemented with dynamic random access memory (DRAM), static random access memory (SRAM), or any other types of memories including those that do not need to be refreshed. The “main” memory 108 may include multiple channels of memory devices such as DRAMs. The DRAMs may include Double Data Rate (DDR2) devices.

The computing device 102 may also include additional memory 110 such as, but not limited to, hard drive memory, removable media drives (for example, CD/DVD drives), card readers, flash memory and so forth. The memory 110 may be connected to the processor core 104 in a variety of ways such as via Integrated Drive Electronics (IDE), Advanced Technology Attachment (ATA), Serial ATA (SATA), Universal Serial Bus (USB), and so on. The memory 110 may also include one or more application modules 112 stored thereon that may be executed by the computing device 102 to provide a variety of functionality to the computing device 102. Examples of application modules 112 include, but are not limited, to an operating system, a browser, office productivity modules, games, email, photo editing and storage, multimedia management/playback, and the like. A variety of other examples are also contemplated.

As noted above, the computing device 102 may also include one or more wireless radio systems 200. The wireless radio systems 200 may include one or more antennas 114a-n, wireless radio module 116a-n, and modified controlled impedance coaxial cables 118a-n. For example, each antenna 114 may be communicatively coupled to a wireless radio module 116a-n via a modified controlled impedance coaxial cables 118a-n, for example, a radio frequency (RF) coaxial cable. The antennas 114a-n and wireless radio modules 116 a-n may be located anywhere within/on the computing device 102. While the location of the antennas 114a-n and/or wireless radio modules 116a-n may be determined based on the specific application (for example, but not limited to, the size and/or shape limitations of the computing device 102), the antennas 114a-n may be disposed within the lid 120 while the wireless radio modules 116a-n may be disposed within the base 122. Those of ordinary skill in the art will recognize that the exact locations of the antennas 114a-n and/or wireless radio modules 116a-n may vary depending on the specific application and that the present disclosure is not limited to the arrangement illustrated unless specifically claimed as such.

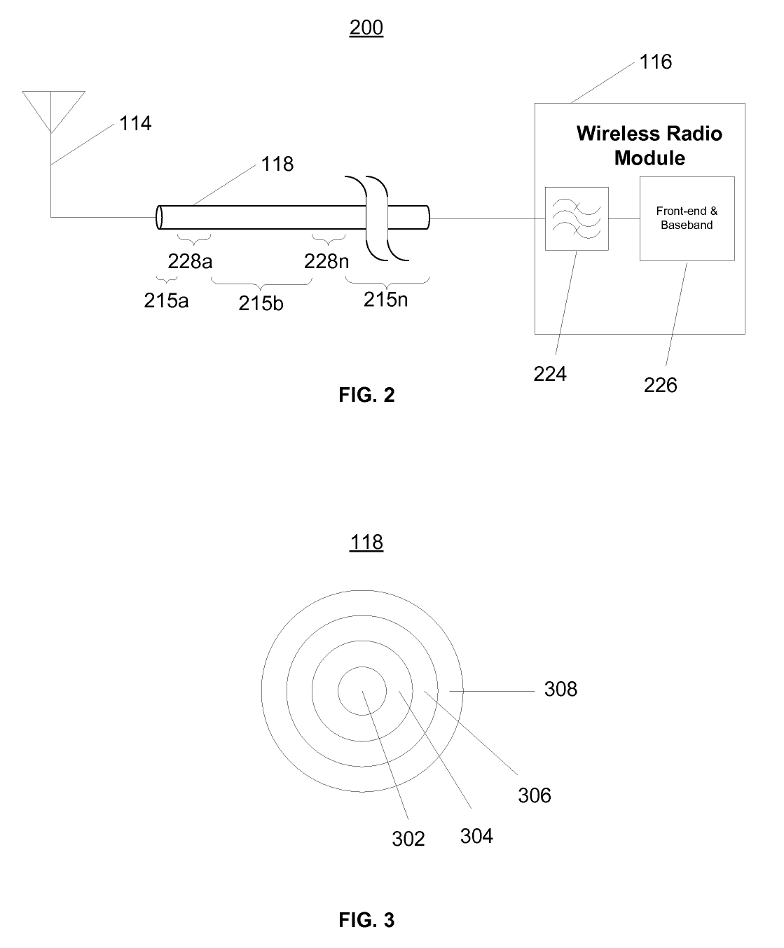

Turning now to FIG. 2, one embodiment of a wireless radio systems 200 consistent with FIG. 1 is generally illustrated. Wireless radio system 200 may include an antenna 114 and a wireless radio module 116 connected via a modified controlled impedance coaxial cable 118. The wireless radio module 116 may optionally include one or more band pass filters 224 configured to reject OOB interference from non-desired radio frequencies. Additionally (or alternatively), the wireless radio module 116 may also include one or more additional front-end and baseband filters 226.

According to at least one embodiment, the modified controlled impedance coaxial cable 118 may include at least one section 215a-n having a first impedance and at least one discontinuity section 228a-n. The first impedance section 215a-n may have any impedance. For example, the first impedance section 215a-n may include a 50 ohm RF coaxial cable such as, but not limited to, RG58, RG142, RG174, RG188, RG213, RG223, RG316, and the like. The present disclosure will refer to the first impedance section 215a-n as “a standard coaxial cable section 215a-n”; however, it will be understood that the first impedance section 215a-n is not limited to a 50 ohm RF coaxial cable unless specifically claimed as such.

The discontinuity section 228a-n may have a different impedance compared to the standard coaxial cable section 215a-n. Each discontinuity section 228a-n may have the same impedance; however, one or more of the discontinuity sections 228a-n may have a different impedance compared to one or more of the other sections 228a-n. As discussed herein, the length and/or number of the discontinuity sections 228a-n may be selected to allow one or more frequencies or frequency ranges to pass through the modified controlled impedance coaxial cable 118 with minimal attenuation while other frequencies or frequency ranges are either reflected and/or attenuated. As a result, a modified controlled impedance coaxial cable 118 consistent with the present disclosure may have two or more impedances along the length of the cable 118 rather than a constant impedance and the discontinuity sections 228a-n may therefore provide in-line filtering.

Turning now to FIG. 3, a cross-sectional view of one embodiment of a modified controlled impedance coaxial cable 118 is generally illustrated. The modified controlled impedance coaxial cable 118 may include an inner conductor 302 surrounded by a tubular insulating layer 304 (for example, but not limited to, a flexible material with a high dielectric constant, also referred to as the dielectric layer). Both the inner conductor 302 and the insulating layer 304 may be surrounded by a conductive layer 306 (also referred to as the metallic shield 306). The conductive layer 306 may include a fine woven wire and/or a thin metallic foil. The inner conductor 302, insulating layer 304, and the conductive layer 306 may optionally be surrounded (e.g., covered) with a thin insulating and/or protective layer 308 (also referred to as the outer jacket or sheath 308). It should be understood, however, that one or more of the layers 302-308 may be eliminated, added, or replaced with other layers. Additional layers (such as, but not limited to, environmental protection layers including UV protection and the like) may also be added to the modified controlled impedance coaxial cable 118 depending on the intended application.

The impedance of the various sections 215a-n, 218a-n of the modified controlled impedance coaxial cable 118 may be determined, for example, based on the ratios of the diameters of the inner conductor 302, and outer diameter of dielectric layer 304 (inner diameter of outer conductive layer 306), as well as the configuration, dielectric material properties, and spacing of the layers 302-306 relative to one another. The impedance of coaxial cable 118 may be independent of the dimensions of the outer jacket 308. The length of the standard coaxial cable section 215a-n may have little impact on the overall impedance of the modified controlled impedance coaxial cable 118. For example, the following formula may be used for calculating the characteristic impedance of the modified controlled impedance coaxial cable 118 at the various sections 215a-n, 218a-n:

impedance=(138/ê(1/2))*log₁₀(D/d)

Wherein d equals the diameter of the inner conductor 302, D equals the inner diameter of the cable shield 306 and e equals the dielectric constant of the dielectric layer 304.

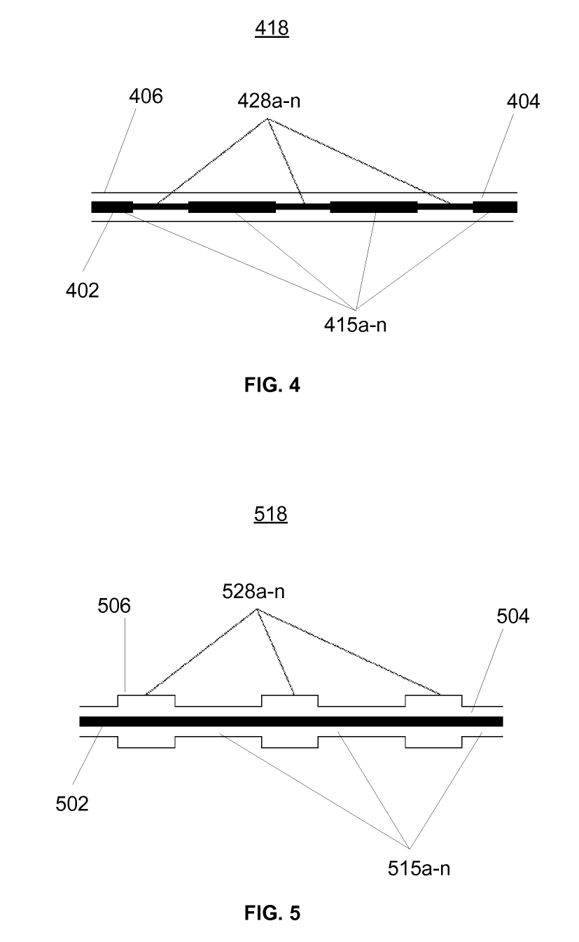

Turning now to FIG. 4, one embodiment of a modified controlled impedance coaxial cable 418 consistent with the present disclosure is generally illustrated. The modified controlled impedance coaxial cable 418 may an inner conductor 402, a dielectric layer 404, and an outer conductor 406. The modified controlled impedance coaxial cable 418 may also include one or more discontinuity sections 428a-n each having an impedance which is different than the impedance of the standard coaxial cable sections 415a-n. In particular, the modified controlled impedance coaxial cable 418 may be modified by crimping the inner conductor 402 to form one or more discontinuity sections 428a-n with an inner conductor 402 having a reduced overall diameter relative to the overall diameter of the inner conductor 402 in the standard coaxial cable sections 415a-n. Optionally, the overall thickness of the dielectric layer 404 may also be reduced in sections 428a-n relative to the thickness of the dielectric layer 404 in the standard coaxial cable sections 415a-n. As a result, the modified controlled impedance coaxial cable 418 may include discontinuity sections 428a-n each having an impedance which is different than the impedance of the standard coaxial cable sections 415a-n.

FIG. 5 illustrates another embodiment of a modified controlled impedance coaxial cable 518. In particular, the modified controlled impedance coaxial cable 518 may include one or more discontinuity sections 528a-n in which the outer diameter of the dielectric layer 504 and/or the inner diameter of the conductive layer 506 is increased relative to the outer diameter of the dielectric layer 504 and/or the inner diameter of the conductive layer 506 in the standard coaxial cable sections 515a-n. Extending the outer diameter of the dielectric layer 504 and/or the inner diameter of the outer conductive layer 506 of the discontinuity sections 528a-n relative to the standard coaxial cable sections 515a-n may therefore change the ratio between the outer diameters of the dielectric layer 504 and the inner conductor 502 relative to the layers in the sections 528a-n or 515a-n, thereby changing the impedance of the discontinuity sections 528a-n such that each section 528a-n has an impedance which is different than the impedance of the standard coaxial cable sections 515a-n of the modified controlled impedance coaxial cable 518.

The present disclosure also discloses systems and methods for manufacturing a modified controlled impedance coaxial cable 118, FIG. 3, having one or more standard coaxial cable sections 315a-n and discontinuity sections 328a-n. As described herein, any one or more of the various layers 302-306 of the modified controlled impedance coaxial cable 118 may be modified such that the discontinuity sections 328a-n have an impedance different from the standard coaxial cable sections 315a-n. While the systems and methods may be described individually for the sake of brevity, one of ordinary skill in the art will understand that a modified controlled impedance coaxial cable 118 may be manufactured using any combination of the systems and methods described herein. For example, any one or more of the various layers 302-306 of the modified controlled impedance coaxial cable 118 may be manufactured using one or more of the systems and methods described herein.

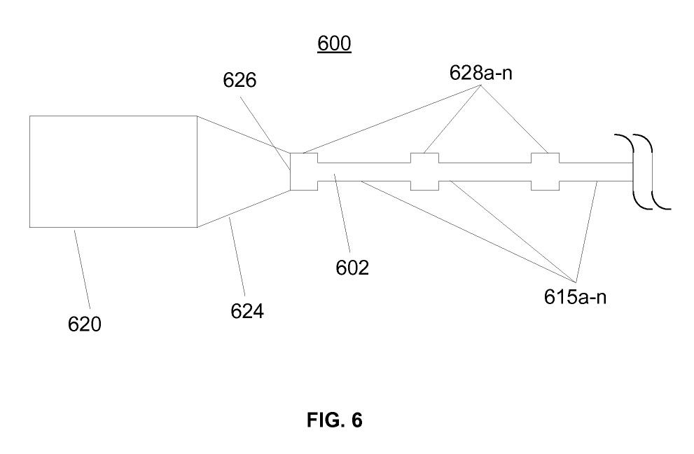

Turning now to FIG. 6, one embodiment of a system 600 and method for manufacturing an inner conductor 602 including one or more discontinuity sections 628a-n each having a different impedance compared to the standard coaxial cable sections 615a-n is generally illustrated. In particular, the inner conductor 602 may include a single conductor (e.g., a “wire”) which may be formed, for example, using an extruder 620. The extruder 620 may include a die 624 having an adjustable diameter nozzle 626 which may be selectively adjusted (for example, increased or decreased) to change the overall diameter of the inner conductor 602 in one or discontinuity sections 628a-n relative to the standard coaxial cable sections 615a-n of the inner conductor 602. When the inner conductor 602 is combined with the dielectric layer, outer conductive layer, and/or shielding layer (not shown), the modified controlled impedance coaxial cable 118 may include one or more discontinuity sections 628a-n having different impedances compared to the standard coaxial cable sections 615a-n.

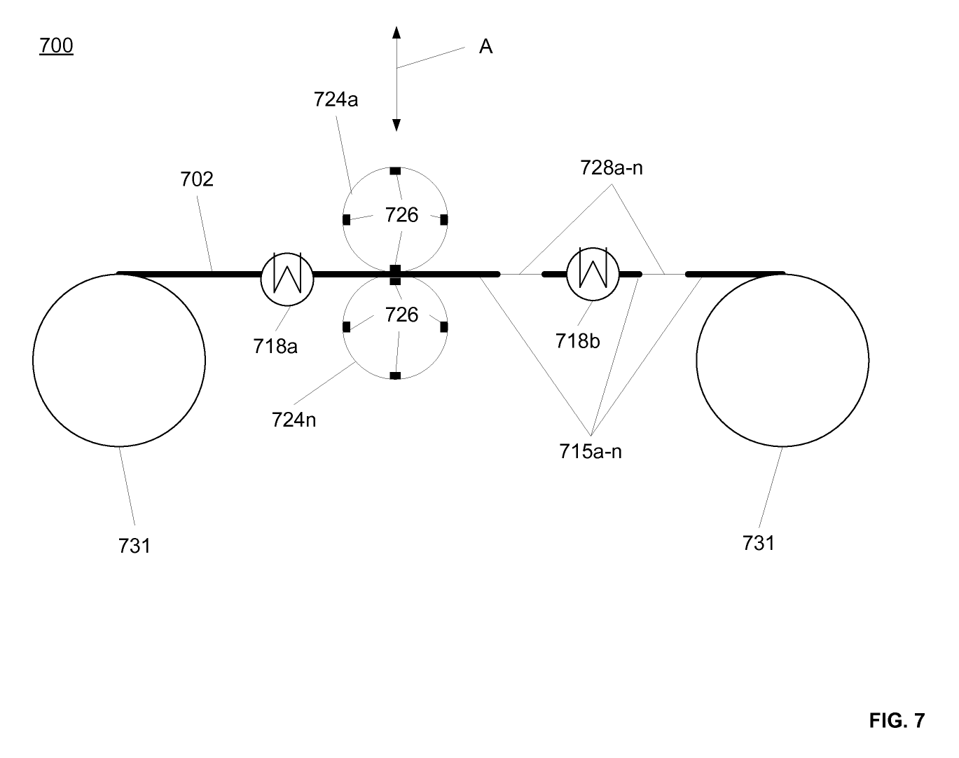

Turning now to FIG. 7, another embodiment of a system 700 and method for manufacturing an inner conductor 702 including one or more discontinuity sections 728a-n each having a different impedance compared to the standard coaxial cable sections 715a-n is generally illustrated. In particular, the inner conductor 702 may include a wire or multistranded wire having a substantially constant overall diameter which may be unwound from a reel 731 or provided from an extruder, twister, braider, or the like (not shown). The inner conductor 702 may be fed through one or more rotating wheels or dies 724a-n which may increase and/or decrease the diameter of the inner conductor 702 in discontinuity sections 728a-n relative to the standard coaxial cable sections 715a-n.

According to one embodiment, the dies 724a-n may move along arrow A generally towards and away from each other. As the dies 724a-n move towards each other, the overall diameter of the inner conductor 702 may be reduced in at least one cross-sectional direction to form one or more discontinuity sections 728a-n having a different overall diameter relative to the standard coaxial cable sections 715a-n.

Alternatively, the dies 724a-n may be stationary relative to each other and one or more of the dies 724a-n may include one or more indentations and/or protrusions 726 configured to reduce the diameter of the inner conductor 702 to form the discontinuity sections 728a-n.

According to yet another embodiment, the system 700 may stretch the inner conductor 702, thereby reducing the outer diameter of the inner conductor 702 to form discontinuity sections 728a-n. For example, the system 700 may optionally include one or more heaters 718a which may heat the inner conductor 702, for example to a temperature at and/or near the glass transition and/or melting point. The heated inner conductor 702 may then be fed into one or more wheels 724a-n which may stretch the heated inner conductor 702, thereby reducing the overall diameter to form one or more discontinuity sections 728a-n with a different overall diameter relative to the standard coaxial cable sections 715a-n. The system 700 may also optionally include one or more coolers 718b to reduce the temperature of the inner conductor 702, for example, after the discontinuity sections 728a-n have been formed.

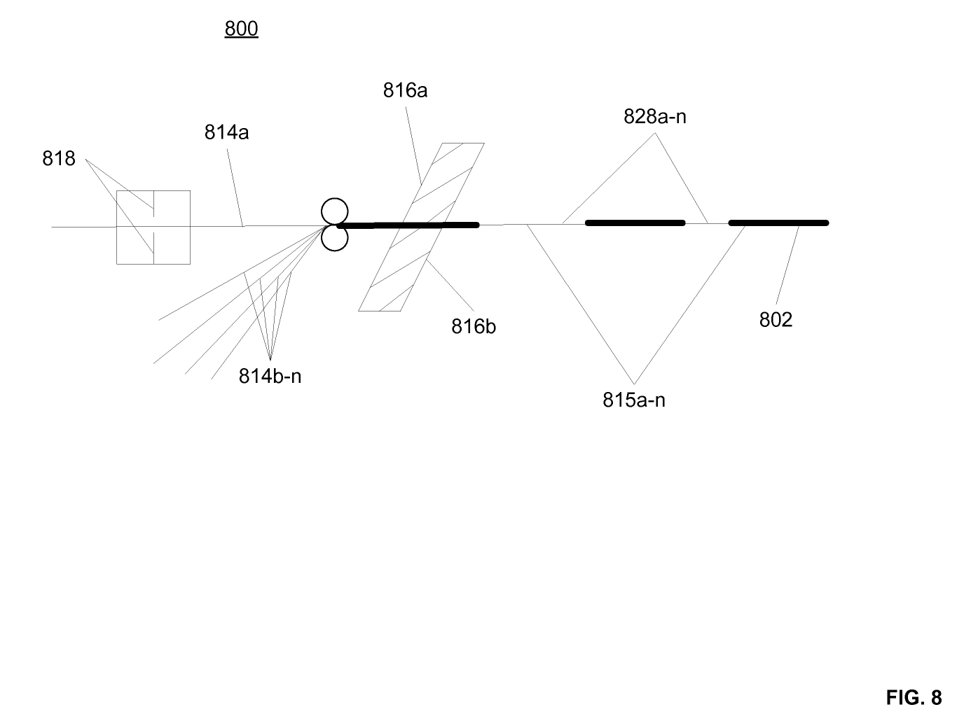

Turning now to FIG. 8, yet another embodiment of a system 800 and method for manufacturing an inner conductor 802 including one or more discontinuity sections 828a-n each having a different impedance compared to the standard coaxial cable sections 815a-n is generally illustrated. In particular, the inner conductor 802 may include a stranded, twisted and/or braided conductor including a plurality of conductors/wires 814a-n in which one or more individual conductors/wires 814a-n may be selectively added and/or removed to form discontinuity sections 828a-n. For example, a plurality of individual wires 814a-n may be bundled together to form the inner conductor 802 using one or more pairs of rotating wheels 816a-b. However, it should be appreciated that any device and method may be used to bundle the plurality of individual wires 814a-n to form the inner conductor 802. The system 800 may also be configured to selective add and/or remove one or more of the plurality of individual wires 814a-n to form discontinuity sections 828a-n having a different diameter compared to the standard coaxial cable sections 815a-n of the inner conductor 802. For example, the system 800 may include one or more cutters 818 each configured to selectively remove a length of one or more wires (for example, but not limited to, wire 814a), thereby changing the overall diameter of the inner conductor 802 in one or more discontinuity sections 828a-n relative to the overall diameter of the inner conductor 802 of the standard coaxial cable sections 815a-n. Alternatively (or in addition), the system 800 may also be configured to selectively add one or more additional wires 814a-n to increase the overall diameter of the inner conductor 802 in one or more discontinuity sections 828a-n.

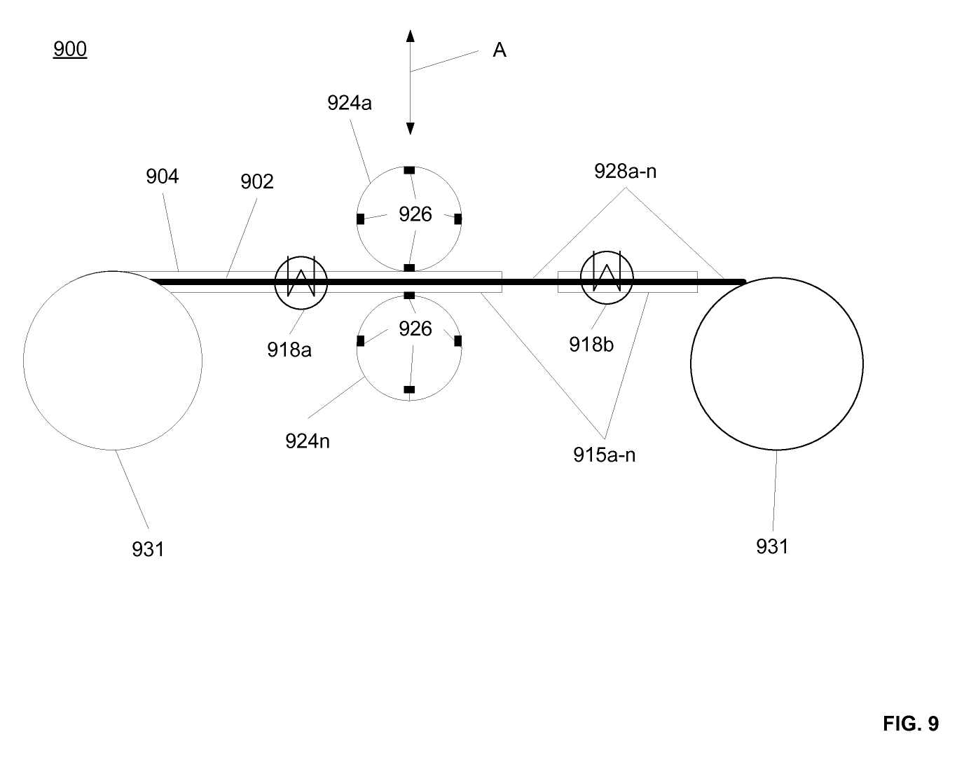

With reference now to FIG. 9, a system 900 and method for manufacturing a dielectric layer 904 including one or more discontinuity sections 928a-n having a different impedance compared to the standard coaxial cable sections 915a-n is generally illustrated. In particular, a dielectric layer 904 having a substantially constant overall diameter may be disposed over an inner conductor 902. The dielectric layer 904 and the inner conductor 902 may be fed through one or more rotating wheels or dies 924a-n which reduce the diameter of the dielectric layer 904 in discontinuity sections 928a-n relative to the standard coaxial cable sections 915a-n of the dielectric layer 904. The inner conductor 902 and dielectric layer 904 may optionally be unwound and/or wound onto reels 931.

According to one embodiment, the dies 924a-n may move along arrow A generally towards and away from each other. As the dies 924a-n move towards each other, the overall diameter of the dielectric layer 904 may be reduced in at least one cross-sectional direction to form one or more discontinuity sections 928a-n with a different overall diameter relative to the dielectric layer 904 of the standard coaxial cable sections 915a-n. The dies 924a-n may be configured to reduce the diameter of only the dielectric layer 904 and/or to reduce the diameter of the dielectric layer 904 and the inner conductor 902 in one or more discontinuity sections 928a-n.

Alternatively, the dies 924a-n may be stationary relative to each other and one or more of the dies 924a-n may include one or more indentations and/or protrusions 926 configured to increase and/or reduce the diameter of the dielectric layer 904 and/or inner conductor 902 to form one or more discontinuity sections 928a-n. The dies 924a-n may also be configured to remove either at least a portion of the dielectric layer 904 in one or more of the discontinuity sections 928a-n (for example, but not limited to, all of the dielectric layer 904).

According to yet another embodiment, the system 900 may stretch the dielectric layer 904 and/or inner conductor 902, thereby reducing the outer diameter of the dielectric layer 904 and/or inner conductor 902 to form discontinuity sections 928a-n. For example, the system 900 may optionally include one or more heaters 918a which may heat the dielectric layer 904 and/or inner conductor 902, for example to a temperature at and/or near the glass transition and/or melting point. The heated dielectric layer 904 and/or inner conductor 902 may then be fed into one or more wheels 924a-n which may stretch the heated dielectric layer 904 and/or inner conductor 902, thereby reducing the overall diameter to form one or more discontinuity sections 928a-n with a different overall diameter relative to the standard coaxial cable sections 915a-n. The system 900 may also optionally include one or more coolers 918b to reduce the temperature of the dielectric layer 904 and/or inner conductor 902 after the discontinuity sections 928a-n have been formed.

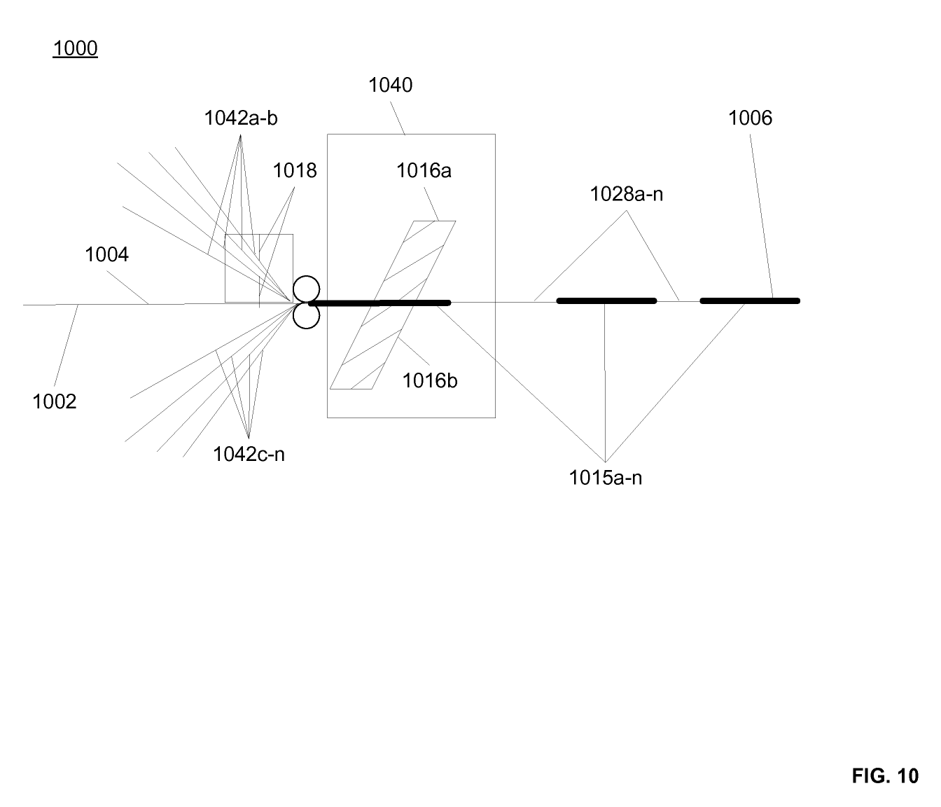

Turning now to FIG. 10, a system 1000 and method for manufacturing an outer conductor 1006 including one or more discontinuity sections 1028a-n having a different impedance compared to the standard coaxial cable sections 1015a-n is generally illustrated. In particular, an inner conductor 1002 and a dielectric layer 1004 may be fed into a braider, weaver, twister or the like (collectively referred to as a twister 1040) which may be configured bundle a plurality of wires 1042a-n over the dielectric layer 1004 to form an outer conductor 1006. For illustrative purposes, the twister 1040 may include a plurality of rotating wheels 1016a-b configured to twist the wires 1042a-n over the dielectric layer 1004; however, one of ordinary skill in the art will recognize that other devices for twisting, weaving, braiding, or the like may be used. The braider 1040 may be configured to create one or more discontinuity sections 1028a-n, for example, by adding and/or removing one or more wire sections 1042a-n, thereby changing the impedance of the discontinuity sections 1028a-n relative to the standard coaxial cable sections 1015a-n. For example, the system 1000 may include one or more cutters 1018 configured to remove a portion of one or more of the wires 1042a-b to form one or more discontinuity sections 1028a-n. As may be appreciated, care should be taken when removing wires 1042a-b to prevent leakage of the signal to be transmitted. Additionally (or alternatively), the system 1000 may be configured to selectively add one or more wires 1042a-b having different impedance properties compared to the other wires 1042c-n. The additional wires 1042a-b may change the impedance in one or more of the discontinuity sections 1028a-n.

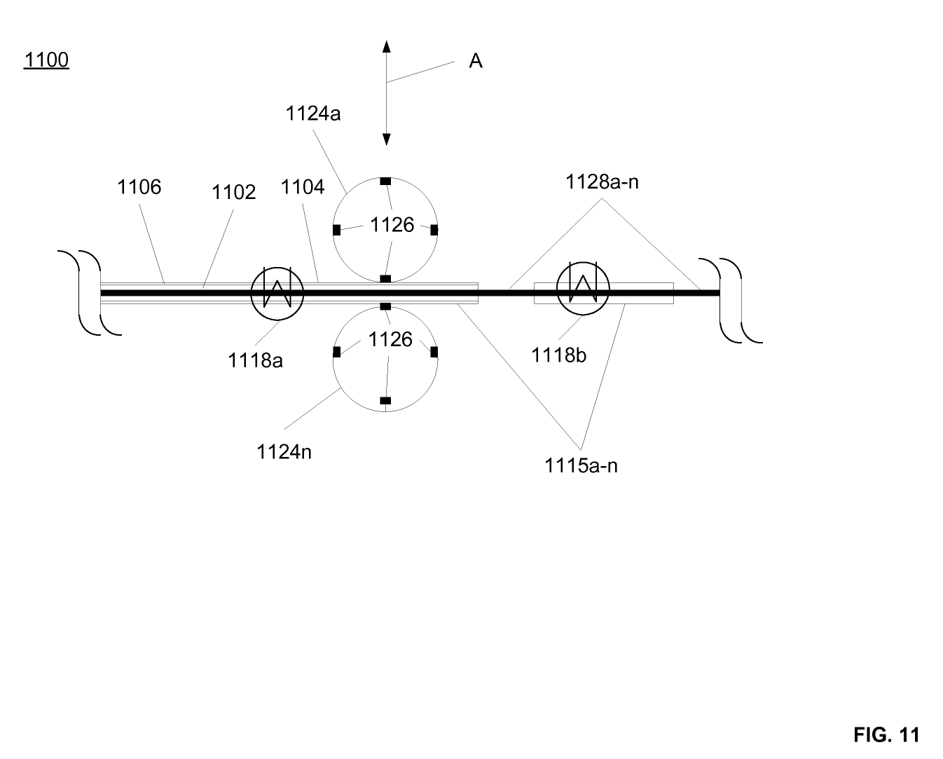

With reference to FIG. 11, another system 1100 and method for manufacturing an outer conductor 1106 including one or more discontinuity sections 1128a-n having a different impedance compared to the outer conductor 1106 of the standard coaxial cable sections 1115a-n is generally illustrated. In particular, an outer conductor 1106 having a substantially constant overall diameter may be disposed over an inner conductor 1102 covered with a dielectric layer 1104. The outer conductor 1106, inner conductor 1102, and dielectric layer 1104 may be fed through one or more rotating wheels or dies 1124a-n which may increase and/or decrease the diameter of one or more of the outer conductor 1106, inner conductor 1102, and dielectric layer 1104 relative to the standard coaxial cable sections 1115a-n to form discontinuity sections 1128a-n.

According to one embodiment, the dies 1124a-n may move along arrow A generally towards and away from each other. As the dies 1124a-n move towards each other, the overall diameter of the outer conductor 1106 may be reduced in at least one cross-sectional direction to form one or more discontinuity sections 1128a-n with a different overall diameter relative to of the outer conductor 1106 of the standard coaxial cable sections 1115a-n. The dies 1124a-n may also reduce the diameter of the dielectric layer 1104 and/or the inner conductor 1102.

Alternatively, the dies 1124a-n may be stationary relative to each other and one or more of the dies 1124a-n may include one or more indentations and/or protrusions 1126 configured to or reduce the diameter of the outer conductor 1106 in the discontinuity sections 1128a-n. Again, the dies 1124a-n may also reduce the diameter of the dielectric layer 1104 and/or the inner conductor 1102.

According to yet another embodiment, the system 1100 may stretch the outer conductor 1106, thereby reducing the outer diameter of the outer conductor 1106 to form discontinuity sections 1128a-n. For example, the system 1100 may optionally include one or more heaters 1118a which may heat the outer conductor 1106, for example to a temperature at/near the glass transition and/or melting point. The heated outer conductor 1106 may then be fed into one or more wheels 1124a-n which may stretch the heated outer conductor 1106, thereby reducing the overall diameter in discontinuity sections 1128a-n relative to the standard coaxial cable sections 1115a-n. The system 1100 may also optionally include one or more coolers 1118b to reduce the temperature of the outer conductor 1106 after the discontinuity sections 1128a-n have been formed. Again, the system 1100 may also be configured to reduce the diameter of dielectric layer 1104 and/or the inner conductor 1102 at the same time as the outer conductor. Care should be taken when stretching the outer conductor 1106 to prevent leakage of the signal to be transmitted.

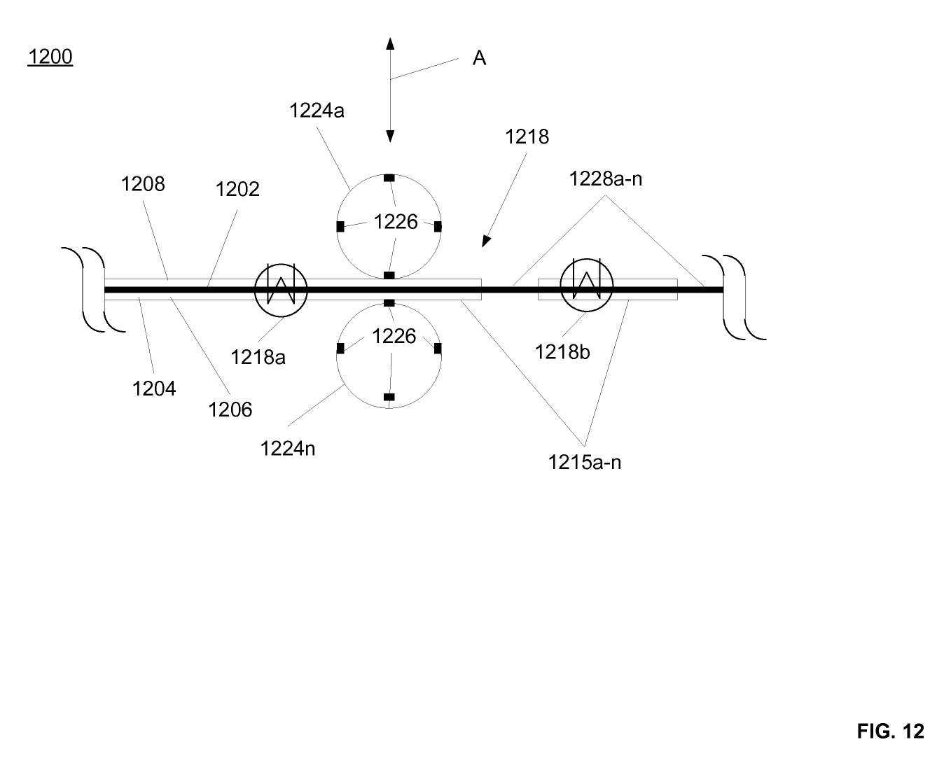

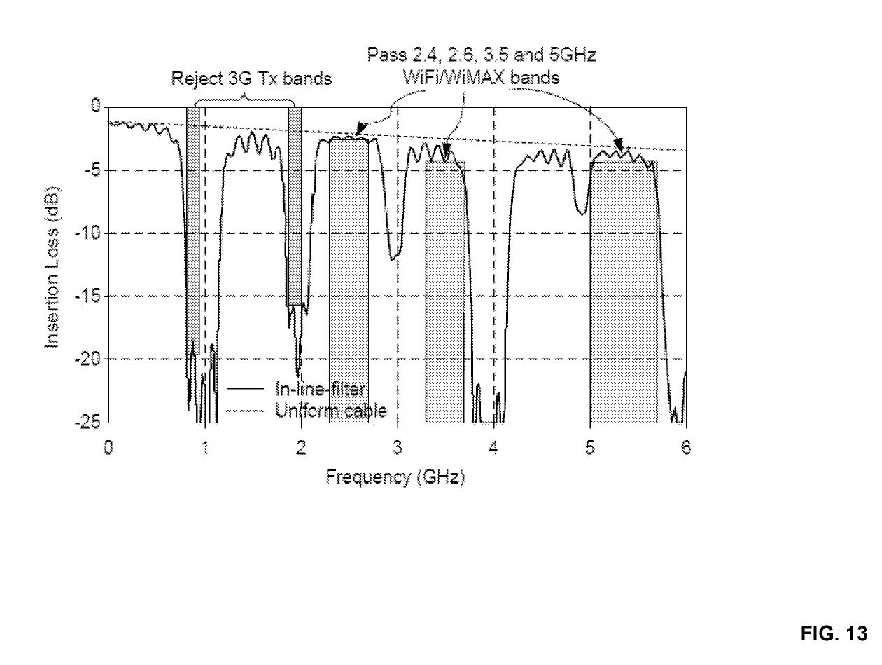

Turning now to FIG. 12, a system 1200 and method for manufacturing a sheath 1208 including one or more discontinuity sections 1228a-n having a different impedance compared to the sheath 1208 of the standard coaxial cable sections 1215a-n is generally illustrated. In particular, a sheath 1208 having a substantially constant overall diameter may be disposed over an inner conductor 1202 covered with a dielectric layer 1204 and an outer conductor 1206. The sheath 1208, outer conductor 1206, inner conductor 1202, and dielectric layer 1204 may be fed through one or more rotating wheels or dies 1224a-n which may decrease the diameter of the sheath 1208 and one or more of the outer conductor 1206, inner conductor 1202, and dielectric layer 1204 relative to the standard coaxial cable sections 1215a-n to form discontinuity sections 1228a-n.

According to one embodiment, the dies 1224a-n may move along arrow A generally towards and away from each other. As the dies 1224a-n move towards each other, the overall diameter of the modified controlled impedance coaxial cable 1218 may be reduced in at least one cross-sectional direction to form one or more discontinuity sections 1228a-n with a different overall diameter relative to the standard coaxial cable sections 1215a-n. The dies 1224a-n may also reduce the diameter of the sheath 1208 and at least one of the outer conductor 1206, the dielectric layer 1204 and/or the inner conductor 1202.

Alternatively, the dies 1224a-n may be stationary relative to each other and one or more of the dies 1224a-n may include one or more indentations and/or protrusions 1226 configured to increase and/or reduce the diameter of the sheath 1208 in the discontinuity sections 1228a-n. Again, the dies 1224a-n may also reduce the diameter of the sheath 1208, the dielectric layer 1204 and/or the inner conductor 1202.

According to yet another embodiment, the system 1200 may stretch the modified controlled impedance coaxial cable 1218 (e.g., the sheath 1208 and at least one of the outer conductor 1206, dielectric layer 1204, and/or inner conductor 1202) thereby reducing the outer diameter of the modified controlled impedance coaxial cable 1218 to form discontinuity sections 1228a-n. For example, the system 1200 may optionally include one or more heaters 1218a which may heat the modified controlled impedance coaxial cable 1218, for example to a temperature at/near the glass transition and/or melting point. The heated modified controlled impedance coaxial cable 1218 may then be fed into one or more wheels 1224a-n which may stretch the heated modified controlled impedance coaxial cable 1218, thereby reducing the overall diameter in discontinuity sections 1228a-n relative to the standard coaxial cable sections 1215a-n. The system 1200 may also optionally include one or more coolers 1218b to reduce the temperature of the modified controlled impedance coaxial cable 1218 after the discontinuity sections 1228a-n have been formed.

The insertion loss of an exemplary modified controlled impedance coaxial cable consistent with at least one embodiment of the present disclosure is generally illustrated in FIG. 13. The modified controlled impedance coaxial cable may include standard, 50 Ohm coaxial cable section which is approximately 62 mm and a discontinuity section which is approximately 42 mm. The modified controlled impedance coaxial cable may have a copper inner conductor and outer conductor and a dielectric layer of Teflon having a dielectric constant of 2.08. The inner conductor has a diameter of 0.3 mm and the outer conductor and dielectric layer each have an outer diameter of 1 mm and 3 mm, respectively, in the 50 Ohm coaxial cable section.

For example, a modified controlled impedance coaxial cable for a 2.4 GHz WiFi radio may be configured to reject 3G signals (e.g., signals at and below 2 GHz) while passing WiFi, WiMAX frequencies (e.g., 2.4 GHz, 2.6 GHz, 3.5 GHz, and 5 GHz). Such an arrangement may improve the antenna isolation between WiFi and 3G antennas and provide stronger rejection to uplink signal around 2 GHz transmitted by a 3G radio co-located on the same computing device platform and operating concurrently. Similarly, a modified controlled impedance coaxial cable may also be configured to operate at the Bluetooth radio transmitting band (e.g., 2.4 GHz range) to limit its out of band emission in 2.5 GHz band, which could significantly degrade a WiMAX radio's performance. Moreover, the modified controlled impedance coaxial cable may be configured to operate in the DTV radio band and to reject 3G radio band uplink frequencies (e.g., 700-900 MHz) to ensure a good UHF DTV reception.

Accordingly, the modified controlled impedance coaxial cable may improve the isolation between antennas of two different radios operating at close frequency bands, lowering susceptibility to front-end saturation due to very strong OOB interference signals. Additionally, the modified controlled impedance coaxial cable may improve the radio co-existence performances.

According to one aspect, there is disclosed a method for manufacturing a modified impedance coaxial cable. The method may include obtaining a coaxial cable having an inner conductor, a dielectric layer at least partially covering an outer surface of the inner conductor, and an outer conductor at least partially covering an outer surface of the dielectric layer. As used herein, the term “obtaining” is intended to mean either acquiring a coaxial cable which has already been manufactured as well as manufacturing a coaxial cable. The coaxial cable may include a first section having a first impedance configured to allow a first frequency band to pass. A discontinuity section may be formed in at least one of the inner conductor, the dielectric layer, and the outer conductor. The discontinuity section may have an impedance different than said first impedance and a length configured to attenuate a second frequency band.

According to another aspect, there is disclosed a method including forming a coaxial cable having a dielectric layer disposed around a least a portion of an inner conductor, the coaxial cable including a first section configured to allow a first frequency band to pass; and selectively modifying the coaxial cable to form a plurality of discontinuity sections, wherein at least one of the inner conductor, the dielectric layer, and the outer conductor has a different diameter in the discontinuity sections compared to the first section such that the each of the plurality of discontinuity sections has a length configured to attenuate a second frequency band.

According to yet another aspect, there is disclosed a method including forming a coaxial cable by selectively forming a first section and at least one discontinuity section, wherein the first section has a first impedance configured to allow a first frequency band to pass, and wherein at least one of an inner conductor, a dielectric layer, and an outer conductor of the coaxial cable has a different impedance in the discontinuity sections compared to the first impedance such that the each of the plurality of discontinuity sections is configured to attenuate a second frequency band.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method of manufacturing a modified impedance coaxial cable, said method comprising:
obtaining a coaxial cable comprising an inner conductor, a dielectric layer at least partially covering an outer surface of said inner conductor, and an outer conductor at least partially covering an outer surface of said dielectric layer, said coaxial cable including a first section having a first impedance configured to allow a first frequency band to pass; and
forming a discontinuity section in at least one of said inner conductor, said dielectric layer, said outer conductor, and said sheath, said discontinuity section having an impedance different than said first impedance and a length configured to attenuate a second frequency band.

2. The method of claim 1, wherein said first and said second frequency bands are selected from the group consisting of 3G, WiFi, WiMAX, Bluetooth, LTE, GPS, and DTV radio.

3. The method of claim 1, further comprising extruding said inner conductor having a first diameter in said first section and a second diameter in said discontinuity section.

4. The method of claim 1, wherein forming said discontinuity section comprises crimping at least one of said inner conductor, said dielectric layer, and said outer conductor to form said discontinuity section having a smaller diameter than said first section in at least one cross-sectional dimension.

5. The method of claim 1, wherein forming said discontinuity section comprises bundling a different number of wires together of at least one of said inner conductor, said dielectric layer, and said outer conductor to form said discontinuity section having a diameter different than said first section in at least one cross-sectional dimension.

6. The method of claim 1, wherein forming said discontinuity section comprises stretching at least one of said inner conductor, said dielectric layer, and said outer conductor to form said discontinuity section having a diameter smaller than said first section in at least one cross-sectional dimension.

7. The method of claim 6, further comprising heating at least one of said inner conductor and said dielectric layer in said discontinuity section prior to stretching.

8. The method of claim 1, wherein forming said discontinuity section comprises changing the material of at least one of said inner conductor, said dielectric layer, and said outer conductor compared to said first section to form said discontinuity section.

9. The method of claim 1, further comprising forming a plurality of discontinuity sections.

10. The method of claim 9, wherein said plurality of discontinuity sections each have the same impedance.

11. The method of claim 9, wherein said plurality of discontinuity sections comprise at two different impedances.

12. The method of claim 2, wherein said first section has an impedance of 50 Ohms.

13. A method comprising:
forming a coaxial cable including a dielectric layer disposed around a least a portion of an inner conductor, said coaxial cable including a first section configured to allow a first frequency band to pass; and
selectively modifying said coaxial cable to form a plurality of discontinuity sections, wherein at least one of said inner conductor, said dielectric layer, and said outer conductor has a different diameter in said discontinuity sections compared to said first section such that said each of said plurality of discontinuity sections has an impedance and a length configured to attenuate a second frequency band.

14. The method of claim 13, further comprising extruding said inner conductor having a first diameter in said first section and a second diameter in at least one of said plurality of discontinuity sections.

15. The method of claim 13, wherein selectively modifying said coaxial cable to form said plurality of discontinuity sections comprises crimping at least one of said inner conductor, said dielectric layer and said outer conductor to form at least one of said plurality of discontinuity sections having a smaller diameter than said first section in at least one cross-sectional dimension.

16. The method of claim 13, wherein selectively modifying said coaxial cable to form said plurality of discontinuity sections comprises bundling a different number of wires together of at least one of said inner conductor, said dielectric layer, and said outer conductor of said second section to form at least one of said plurality of discontinuity sections having said diameter different than said first section in at least one cross-sectional dimension.

17. The method of claim 13, wherein selectively modifying said coaxial cable to form said plurality of discontinuity sections comprises stretching at least one of said inner conductor and said dielectric layer to form at least one of said plurality of discontinuity sections having a smaller diameter than said first section in at least one cross-sectional dimension.

18. The method of claim 13, wherein said plurality of discontinuity sections each have the same impedance.

19. The method of claim 13, wherein said plurality of discontinuity sections comprise at two different impedances.

20. A method comprising:
forming a coaxial cable by selectively forming a first section and at least one discontinuity section, wherein said first section has a first impedance configured to allow a first frequency band to pass, and wherein at least one of an inner conductor, a dielectric layer, and an outer conductor of said coaxial cable has a different impedance in said discontinuity sections compared to said first impedance such that said each of said plurality of discontinuity sections is configured to attenuate a second frequency band.

21. The method of claim 20, wherein selectively forming said first section and said at least one discontinuity section comprises extruding said inner conductor having a first diameter in said first section and a second diameter in at least one of said plurality of discontinuity sections.

22. The method of claim 20, wherein selectively forming said at least one discontinuity section comprises crimping at least one of said inner conductor, said dielectric layer, and said outer conductor to form at least one of said plurality of discontinuity sections having a smaller diameter than said first section in at least one cross-sectional dimension.

23. The method of claim 20, wherein selectively forming said at least one discontinuity section comprises bundling a different number of wires together of at least one of said inner conductor, said dielectric layer, and said outer conductor of said second section to form at least one of said plurality of discontinuity sections having said diameter different than said first section in at least one cross-sectional dimension.

24. The method of claim 20, wherein selectively forming said at least one discontinuity section comprises stretching at least one of said inner conductor, said dielectric layer, and said outer conductor to form at least one of said plurality of discontinuity sections having a smaller diameter than said first section in at least one cross-sectional dimension.
